(19) United States
(12) Patent Application Publication
(10) Pub. No.: US 2007/0117006 A1
(43) Pub. Date: May 24, 2007

(54) Direct Fabrication of Copper Cermet for Use in Solid Oxide Fuel Cell

(76) Inventors: Zhongliang Zhan, King of Prussia, PA (US); Shung Ik Lee, Huntingdon Valley, PA (US); Eduardo E. Paz, Collegeville, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/562,188

(22) Filed: Nov. 21, 2006

Related U.S. Application Data
(60) Provisional application No. 60/738,584, filed on Nov. 22, 2005.

(51) Int. Cl. H01M 8/12; H01M 4/88; H01M 4/90; C04B 35/64

(52) U.S. Cl. 429/45; 502/101; 429/33; 264/618

(57) ABSTRACT

The embodiments generally relate to high performance anodes and electrolyte materials for use in solid oxide fuel cells, whereby the anodes are made of a copper-containing cermet material that is sintered at low temperatures. The embodiments further relate to methods of making electrodes and electrolytes at low sintering temperatures. The methods enable the use of catalytic materials in the electrodes that were not previously possible with conventional high sintering temperature techniques.

This application claims priority under 35 U.S.C. §119(e) to Provisional Patent Application No. 60/738,584 filed on Nov. 22, 2005, the disclosure which is incorporated by reference herein in its entirety.

### FIELD OF THE INVENTION

Embodiments relate generally to solid oxide fuel cells (SOFC) and to methods of their preparation. Specifically, the embodiments relate to ceramic anodes and electrolytes and methods of making ceramic anodes having a high copper loading, whereby the ceramic anodes include a copper cermet prepared by mixing a copper oxide and a ceramic support material, and sintering the mixture to form the ceramic anode. Embodiments also relate to a process of making electrodes and electrolytes by adding a sintering aid to the electrolyte, and then sintering the electrode and electrolyte at low temperatures. Specifically, one embodiment relates to a method of preparing an anode comprised of a copper cermet, whereby the anode contains higher copper loadings than that which is readily achieved by impregnating a porous ceramic support with a copper-containing solution.

### DESCRIPTION OF RELATED ART

Solid oxide fuel cells have grown in recognition as a viable high temperature fuel cell technology. There is no liquid electrolyte, thereby eliminating the metal corrosion and electrolyte management problems typically associated with the use of liquid electrolytes. Rather, the electrolyte of the cells is made primarily from solid ceramic materials that are capable of surviving the high temperature environment typically encountered during operation of solid oxide fuel cells. The operating temperature of greater than about 600° C. allows internal reforming, promotes rapid kinetics with non-precious materials, and produces high quality by-product heat for cogeneration or for use in a bottoming cycle. The high temperature of the solid oxide fuel cell, however, places stringent requirements on its fabrication materials. Because of the high operating temperatures of conventional solid oxide fuel cells (approximately 600 to 1000° C.), the materials used to fabricate the respective cell components are limited by chemical stability in oxidizing and reducing environments, chemical stability of contacting materials, conductivity, and thermomechanical compatibility.

The general operating principles of a solid oxide fuel cell (SOFC) involve introducing an oxygen source such as air to the cathode. The cathode is sometimes fabricated of a composite material, such as a composite of Sr-doped LaMnO₃ (LSM) and yttria-stabilized zirconia (YSZ), and the O₂ is reduced according to the half-cell reaction (1):
O₂+4e⁻=2O²⁻ (1)

The resulting O²⁻ anions are transported through the electrolyte, an electronically insulating but ionically conductive membrane, often yttria-stabilized zirconia (YSZ), to the anode. The anode is frequently composed, at least partially, of a material that is compatible with or the same as the electrolyte, such as porous YSZ. At the anode, the O²⁻ anions are used to oxidize a fuel source to produce electrons. In principle, the O²⁻ anions can react with hydrocarbon fuels at the anode according to reaction (2):
CₙHₘ+(2n+m/2)O²⁻=nCO₂+m/2H₂O+(4n+m)e⁻ (2)

However, in most cases, the hydrocarbon must first be reformed to syngas, a mixture of CO and H₂,before sending it to the anode, so that the actual half-cell reaction involves generating electrons as shown in (3a) and (3b) below:
H₂+O²⁻=H₂O+2e⁻ (3a)
CO+O²⁻=CO₂+2e⁻ (3b)

For large-scale systems, the reforming can be performed internally so that heat for reforming can be supplied by losses in the fuel cell. This makes for a highly efficient process. (Note that the surface areas of the electrodes are typically low, so that, when internal reforming is used, most of the reaction is not performed on the anode itself.) However, for smaller-scale systems, even at 5 kW, it often is necessary to autothermally reform the gas, where a significant fraction of the methane is reformed according to reaction (4):
CH4+½O2=CO+2H2 (4)

Reaction (4) results in significant energy losses for high-temperature fuel cells. First, if air is used as the oxidant, the reaction causes a dilution of the fuel through the addition of 2.0 moles of N₂ for every mole of CH₄ that is oxidized. The targeted fuel use (the fuel conversion) is generally chosen based on the minimum fuel concentration at which the cell can operate, so that this dilution is important. Second, while the enthalpy change for oxidation of CO+2H₂ (the product of Reaction (4)) is only 5% lower than the enthalpy change for oxidation of CH₄, the change in Gibbs Free Energy (ΔG) for oxidation of CO+2H₂ is 28% lower than that for oxidation of CH₄ at 800° C. This distinction is important because the theoretical efficiency of a fuel cell for generation of electricity is ΔG/ΔH. The decrease in ΔG for the reformate implies a significant loss in available energy for the fuel cell. Stated otherwise, CO and H₂ have a lower standard potential than CH₄ at 800° C., and electrochemical oxidation of CO+2H₂ delivers only 6 electrons compared to 8 for CH₄.

The most common anode material for a SOFC, a ceramic-metallic (cermet) composite of Ni and YSZ. Ni-YSZ cermets most often are prepared by high-temperature sintering of mixed NiO and YSZ powders, followed by reduction of the NiO to Ni metal. The best performance usually is achieved when the sintering temperature is greater than 1300° C. to properly sinter the YSZ in the electrode to the YSZ in the electrolyte.

Direct oxidation of hydrocarbon fuels without requiring the formation of syngas is highly desirable. Nickel cermets, however, cannot be used for the direct oxidation process. Ni cermets cannot be used to directly oxidize CH₄ and other hydrocarbon fuels because in the presence of such hydrocarbons, Ni catalyzes carbon-fiber formation which causes fouling of the fuel cells, a process that has been studied intensely because of its importance in steam-reforming catalysis (R. T. K. Baker, M. A. Barber, P. S. Harris, S. D. Feates, and R. J. Waite, J. Catal. 26, 51 (1972); R. T. K. Baker, P. S. Harris, and S. Terry, Nature, 253, 37 (1975)) and in dry corrosion, also known as “dusting” (Chun C. M.; Mumford J. D.; Ramanarayanan T. A. In SOFC VI, Singhal, S. C.; Dokiya, M., Eds.; The Electrochemical Society Proceedings Series PV 1999-19, p 621; Toh, C. H.; Munroe P. R.; Young D. J.; Foger K. Mater. High Temp. 20, 129 (2003)).

Solid oxide fuel cells typically are made by first preparing a cathode/electrolyte structure (e.g., a cathode supported cell), or an anode/electrolyte structure (e.g., anode supported cell), and then sintering the structure. Sintering typically takes place at a temperature high enough to effectively sinter the electrode to the electrolyte material. The high temperature sintering has precluded the use of certain otherwise useful additives in the cathode or anode due to the melting points of such materials, or undersirable solid state reactions that can occur at such high temperatures. In addition, high temperature sintering adds production costs and complexity to the fuel cell production process.

It has recently been shown that it is possible to use hydrocarbon fuels directly when Ni is replaced with an electronic conductor, e.g., Cu or a Cu-containing metal mixture, that does not catalyze the formation of carbon fibers. See, for example, U.S. Pat. Nos. 6,589,680; 6,811,904; 6,844,099; and 6,939,637, the disclosures of which are incorporated by reference herein in their entireties. For example, the Cu or Cu-containing mixture provides electronic conductivity and possibly catalytic activity in the electrode.

Cu cermets cannot be prepared using the high-temperature methods commonly used with Ni cermets because of the low melting temperatures of Cu and Cu-containing mixtures. Because Cu₂O and CuO melt at 1235 and 1326° C. respectively, (temperatures below that necessary for densification of YSZ electrolytes as well as sintering the ceramic layers together), it is not possible to prepare Cu-YSZ cermets by high-temperature calcination of mixed powders of CuO and YSZ, a method analogous to that usually used as the first step to produce Ni-YSZ cermets. An alternative method for preparation of Cu-YSZ cermets was therefore developed in which a porous YSZ matrix was prepared first, followed by addition of Cu and an oxidation catalyst in subsequent processing steps (R. J. Gorte, et al., Adv. Materials, 12, 1465 (2000); S. Park, et al, J. Electrochem. Soc., 148, A443 (2001)).

This two-step process permits the use of high sintering temperatures for sintering the ionic conductor to the electrolyte and lower temperatures for the remaining components. For example, the addition of the electronic and catalytic components may be accomplished by impregnation of the electrolyte with a solution of the relevant materials. In general, the porous electrode is dipped in an aqueous solution of metal salts at room or low temperature. The anode is removed from solution and allowed to dry, which results in a coating of the salts (typically nitrate salts) in the pores. The salts are heated in air to decompose the nitrates and form oxides, which are then reduced in H₂ to leave a coating of metal inside of the pores. While such an impregnation process allows unprecedented control over composition and structure, the process can be tedious, requiring many impregnation steps. In addition, the loading of the impregnated metal is limited and can reach a saturation point, thus sometimes precluding high metal loadings in the anode.

The description herein of advantages and disadvantages of various features, embodiments, methods, and apparatus disclosed in other publications is in no way intended to limit the present invention. Indeed, certain features of the invention may be capable of overcoming specific disadvantages, while still retaining some or all of the features, embodiments, methods, and apparatus disclosed therein.

### SUMMARY

It would be desirable to provide a solid oxide fuel cell that has high fuel efficiency, electrical conductivity, high power, and is capable of directly oxidizing hydrocarbons. It also would be desirable to provide anode materials, and methods of preparing the anode materials for use in solid oxide fuel cells, whereby the materials are capable of direct oxidation of hydrocarbons, in a simple process that provides high conductive material loadings. It also would be desirable to provide a method of manufacturing an electrode whereby sintering of the electrode/electrolyte composite takes place at a lower temperature than conventional sintering operations, thereby enabling the use of materials that could not be used if a higher sintering temperature were used. A feature of an embodiment, therefore, is to provide a solid oxide fuel cell that has high fuel efficiency, electrical conductivity, high power, and is capable of directly oxidizing hydrocarbons. Embodiments include anode materials, methods of making the anode materials, and methods of making the solid oxide fuel cells.

In accordance with these and other features of various embodiments, there is provided an anode comprising a porous ceramic mixture of at least copper and a ceramic electrolyte material, whereby the porous ceramic mixture contains a higher amount of copper than that achieved by impregnating a porous ceramic electrolyte material with a copper-containing solution, or by coating a porous ceramic material with copper. The anode also may not include any, or only negligible amounts of copper that has melted.

In accordance with an additional feature of an embodiment, there is provided a method of making a porous ceramic anode material comprising forming a ceramic mixture by mixing a ceramic electrolyte material and copper oxide powders to form a copper cermet anode mixture, mixing a ceramic electrolyte material and a sintering aid selected from the group consisting of copper oxides, iron oxides, cobalt oxides and manganese oxides, to provide an electrolyte mixture, forming a structure by positioning the copper cermet anode mixture adjacent the electrolyte mixture, and sintering the structure at a temperature lower than the temperature required to sinter the respective materials without the use of a sintering aid. It is preferred that the sintering aid is added in an amount effective to reduce the sintering temperature of the electrolyte/electrode composite to less than about 1,200° C., and sintering the ceramic mixture at a temperature of less than about 1,200° C. for a period of time sufficient to form a porous ceramic anode material.

In accordance with another feature of an embodiment, there is provided a method of making an electrode comprising mixing a ceramic electrolyte material and an electrode material to form an electrode mixture, mixing a ceramic electrolyte material and a sintering aid to form an electrolyte mixture, and forming a layered composite structure of the electrode material and electrolyte material. The method then comprises sintering the electrode material and electrolyte material at a temperature lower than the temperature required to sinter the respective materials without the use of a sintering aid to form a porous electrode/electrolyte composite. Another embodiment includes mixing another ceramic electrolyte material and an electrode material to form a second electrode mixture and applying the second electrode mixture to the electrode/electrolyte composite on the side of the electrolyte opposite the electrode to provide an electrode/electrolyte/second electrode composite. The method further includes sintering the electrode/electrolyte/second electrode composite at a temperature lower than the temperature required to sinter the respective materials without the use of a sintering aid to form a solid oxide fuel cell.

In accordance with another feature of an embodiment, there is provided a solid oxide fuel cell comprising a solid electrolyte, a cathode material, and the anode described above. In accordance with yet another feature of an embodiment of the invention, there is provided a method of making a solid oxide fuel cell comprising forming a porous ceramic anode material as described above, together with a dense electrolyte, the electrolyte material optionally being prepared from the same ceramic material used to prepare the porous ceramic anode. The method further includes contacting a surface of the electrolyte opposite the surface adjacent the porous ceramic anode material with a cathode material, and forming the cathode.

Another feature of an embodiment provides a solid oxide fuel cell electrolyte that includes conductive materials as sintering aids, preferably in an amount within the range of from about 0.1% to about 10% by weight conductive material, based on the total weight of the electrolyte. Other features include a method of making the electrolyte, and a solid oxide fuel cell containing the electrolyte.

These and other features and advantages of the preferred embodiments will become more readily apparent when the detailed description of the preferred embodiments is read in conjunction with the attached drawings.

### BRIEF DESCRIPTION OF THE DRAWINGS

FIG. 1 is a scanning electron microscope (SEM) image of a porous ceramic anode/ceramic electrolyte microstructure prepared in accordance with example 1.

FIG. 2 is a graph showing the performance of an anode prepared in accordance with example 1, upon exposure to hydrogen.

FIG. 3 is a graph showing the performance of the same anode of FIG. 2, upon exposure to propane.

### DETAILED DESCRIPTION OF THE PREFERRED EMBODIMENTS

The terminology used herein is for the purpose of describing particular embodiments only, and is not intended to limit the scope of the present invention. As used throughout this disclosure, the singular forms “a,” “an,” and “the” include plural references unless the context clearly dictates otherwise. For example, reference to “a solid oxide fuel cell” includes reference to a plurality of such fuel cells in a stack, as well as a single cell, and reference to “an anode” includes reference to one or more anodes and equivalents thereof known to those skilled in the art, and so forth.

Throughout this description, the term “adjacent” denotes immediately next to or near, with one or more layers interposed between the adjacent materials. Throughout this description, the expression “a higher amount of copper than that achieved by impregnating a porous ceramic electrolyte material with a copper-containing solution, or by coating a porous ceramic material with copper” denotes a weight percentage of copper in the ceramic anode material that is greater than the weight percentage of copper in the porous material achieved by impregnating a porous ceramic electrolyte material at least three times with a copper-containing solution and subsequent drying, or by coating the pores of a porous ceramic electrolyte material with copper. Thus, if the amount of copper impregnated into a porous ceramic material after 3 impregnation cycles is 25% copper, then the amount of copper in the ceramic anode of the embodiments described herein is higher than that, and preferably is higher than the amount possible using the impregnation method.

Unless defined otherwise, all technical and scientific terms used herein have the same meanings as commonly understood by one of ordinary skill in the art to which this invention belongs. Although any methods and materials similar or equivalent to those described herein can be used in the practice or testing of the embodiments, the preferred methods, devices, and materials are now described. All publications mentioned herein are cited for the purpose of describing and disclosing the various anodes, electrolytes, cathodes, and other fuel cell components that are reported in the publications and that might be used in connection with the invention. Nothing herein is to be construed as an admission that the invention is not entitled to antedate such disclosures by virtue of prior invention.

Generally, an SOFC includes an air electrode (cathode), a fuel electrode (anode), and a solid oxide electrolyte provided between these two electrodes. In a SOFC, the electrolyte is in solid form. Typically, the electrolyte is made of a nonmetallic ceramic, such as dense yttria-stabilized zirconia (YSZ) ceramic, that is a nonconductor of electrons, which ensures that the electrons must pass through the external circuit to do useful work. As such, the electrolyte provides a voltage buildup on opposite sides of the electrolyte, while isolating the fuel and oxidant gases from one another. The anode and cathode are generally porous, with the cathode oftentimes being made of doped lanthanum manganite, doped lanthanum ferrate (LSF), or doped lanthanum cobaltate (LSCo). In the solid oxide fuel cell, hydrogen or a hydrocarbon is commonly used as the fuel and oxygen or air is used as the oxidant. The solid oxide fuel cells of the embodiments described herein are capable of oxidizing hydrocarbons, without suffering from the adverse affects that ensue when a nickel-containing anode is used to directly oxidize a hydrocarbon.

The most common anode material for SOFC is a ceramic-metallic (cermet) composite of Ni and YSZ. N. Q. Minh, J. Am. Ceram. Soc. 76, 563 (1993). The Ni provides the required electronic conductivity and catalytic activity for H₂ oxidation, as well as promoting the water-gas-shift reaction. The YSZ in the composite maintains thermal stability of the electrode against Ni sintering and provides paths for transport of O²⁻ ions from the electrolyte into the electrode. These ion-conducting pathways are believed to be important for increasing the length of the three-phase boundary (TPB), the zone where the electrochemical reaction occurs. C. W. Tanner, K.-Z. Fung, A. V. Virkar, JECS, 22,144 (1997); Virkar, A. V.; Fung, K. Z.; Tanner, C. W. U.S. Patent No. 5,543,239 (1996). (The TPB is the region where the gas phase, the ionic conductor, and the electronic conductor meet.), As discussed above, however, hydrocarbon fuels cannot be oxidized directly in a SOFC with a Ni-based electrode, because Ni catalyzes carbon fiber formation. Several attempts have been made to optimize the performance of Ni-based electrodes for direct utilization of hydrocarbons such as by modifying the operating conditions, substituting other electronically conductive materials for Ni, and adding catalysts. However, none of these approaches has been commercially successful.

The development of practical electrodes for directly oxidizing carbon containing fuels (e.g., methane and other hydrocarbon fuels) in SOFC, without first reforming the fuels (e.g., from methane to syngas), would provide significant advantages that could improve the rate of commercialization of these devices. Direct-utilization fuel cells are capable of converting chemical to electrical energy at very high efficiencies. Removing the need for a reformer also leads to simplification of the fuel-cell system. Direct utilization of methane could also lead to the commercialization of an innovative new method for H₂ generation, such as natural gas assisted steam electrolysis (NGASE), which has been developed at Lawrence Livermore National Labs, as disclosed in U.S. Pat. No. 6,051,125 to Pham, et al, the disclosure of which is incorporated herein by reference in its entirety. See also, J. Martinez-Frias, A.-Q. Pham, S. M. Aceves, Int. J Hydrogen Energy, 28, 483 (2003). While electrodes capable of direct utilization of methane have been demonstrated by a number of groups, either the performance or the stability of materials that have been tested to date has been insufficient for practical use.

The SOFC of the embodiments can include any solid electrolyte and any cathode made using techniques disclosed in the art. The present embodiments are not limited to any particular material used for the electrolyte or cathode, nor is it particularly limited to their respective methods of manufacture.

The embodiments preferably include an anode, a method of making the anode, and a solid oxide fuel cell containing the anode. The anode comprises a porous ceramic mixture of at least copper and a ceramic electrolyte material, whereby the porous ceramic mixture contains a higher amount of copper than that achieved by impregnating a porous ceramic electrolyte material with a copper-containing solution, or by coating a porous ceramic material with copper. The embodiments also preferably include a method of making an electrode (anode or cathode) by sintering the electrode and electrolyte material at lower temperatures than the sintering temperature required for the same electrode and electrolyte material without the addition of a sintering aid to the electrolyte.

In other embodiments, the addition of a small amount of sintering aid in an electrolyte enables sintering of an electrolyte/electrode composite at a temperature lower than the sintering temperature required for the same electrode and electrolyte material without the addition of a sintering aid to the electrolyte. As a consequence, a variety of new electrodes can be prepared in a simple manner (without the need for additional impregnation and coating steps) using materials not previously possible with conventional sintering. Without the presence of the sintering aid (or conductive material) these materials used in the new electrodes could not be manufactured due to melting of the metal and/or the presence of undesirable solid state reactions occurring at the higher sintering temperatures (e.g., use of chromium or cerium at higher temperatures typically resulted in undesirable by-products that adversely affected the performance of the cell).

It is preferred that the sintering aid be a metal-containing sintering aid. The use of such materials in SOFC electrolytes is counterintuitive since the electrolyte material should not have electronic conductivity. The sintering aid can be the same or similar to the metal or other conductor used in the electrode. In certain embodiments, the use of a small amount of the conductive material as a sintering aid enables low temperature sintering of the electrolyte to the electrode, without significantly deteriorating the performance of the cell (preferably without any deterioration) due to the presence of the sintering aid (conductive material) in the electrolyte.

A number of sintering aids can be used in the embodiments. Preferred sintering aids can be selected from copper oxides, iron oxides, cobalt oxides and manganese oxides. The amount of sintering aid can vary so long as the sintering aid permits sintering at a lower temperature than sintering without the sintering aid, and so long as the amount does not provide any appreciable degree of electronic conductivity to the electrolyte. Preferably, the sintering aid should be from about 0.1% to about 10% by weight sintering aid, based on the total weight of the electrolyte, more preferably from about 0.5% to about 7%, even more preferably from about 1% to about 5% and most preferably from about 2.0% to about 5.0% by weight, based on the total weight of the electrolyte. Using the guidelines provided herein, a skilled artisan will be capable of determining the appropriate sintering aid to use, as well as an appropriate amount of sintering aid.

The present inventors have discovered that a copper cermet anode can be prepared using a simple procedure whereby the anode includes a high loading of copper that could not be achieved by impregnation or conventional coating techniques. The inventors also have discovered a method of sintering the cermet at a temperature below the melting temperature of copper, thereby enabling the production of a copper-containing anode by a method that is less complicated and less expensive than impregnation and coating. One embodiment described herein includes incorporating a sintering aid, e.g., 0.1% to about 10% copper, into a yttria-stabilized zirconia ceramic material, a material typically employed in solid oxide fuel cell electrolytes. Using such a sintering aid permits full sintering of the YSZ at temperatures as low as 1,000° C.

This low temperature sintering of the YSZ makes it possible to directly add copper oxide powders to YSZ powders, and then sintering the powders together to form a copper-YSZ cermet. Ordinarily, copper oxide must be impregnated onto a porous YSZ substrate that has previously been sintered to avoid melting the copper oxide at the temperature normally required to sinter the YSZ (i.e., around 1,400° C. to 1,500° C.). This method may allow copper concentrations high enough to achieve percolation of the copper phase—something that is impossible to achieve through impregnation.

In a preferred embodiment, a sintering aid is added to YSZ in an amount within the range of from about 0.5% to about 7.0% by weight, based on the total weight of the YSZ and sintering aid, and more preferably from about 2.0% to about 5.0% by weight. A preferred sintering aid is copper (typically in the form of copper oxide), especially when copper is used in the anode, although as described above, other sintering aids capable of reducing the sintering temperature of YSZ may be employed in the embodiments. This mixture of YSZ and sintering aid then is used as the electrolyte to form either the cathode-supported or anode-supported cell by sintering at temperatures lower than the temperature required to sinter the respective materials without the sintering aid.

To form the anode, YSZ powders (without the sintering aid) can be directly mixed with copper oxide powders in an amount ranging from about 30:70 to 70:30 weight ratio of copper to YSZ, more preferably from about 40:60 to about 60:40, and most preferably about 50:50. Conventional pore forming additives (e.g., fugitive pore formers) can be added, as well as other additives typically utilized in making solid oxide fuel cell anodes. Additional catalytic materials also can be added to the anode, either before sintering or after sintering, as is known in the art. For example, ceria can be added to the anode before sintering, or can be impregnated into the porous anode after sintering by impregnation with a Ce(NO)₃ solution, followed by drying and calcination.

Upon mixing the anode materials, the mixture can be formed into a slurry by screen printing, or other techniques readily available to the skilled artisan. The slurry then can be applied to an electrolyte material, preferably comprised of the same ceramic material used to form the anode (in the preferred embodiments this ceramic material is YSZ, although other ceramic materials can be used). The electrolyte material can be pre-fabricated and supported by a cathode, (e.g., a cathode-supported cell) or the anode slurry can be cast onto the green electrolyte material prior to forming the cathode (e.g., an anode-supported cell). Again, the electrolyte material preferably includes a sintering aid.

The anode/electrolyte (and optional cathode) structure then can be sintered at a temperature below that at which the copper oxide melts. It is preferred that sintering take place at temperatures less than 1,200° C., more preferably, less than about 1,100° C., and even more preferably, less than about 1,000° C. It is possible in the embodiments to sinter the anode-containing structure at temperatures as low as 900° C., for about 4 hours.

It is preferred to use a screen printing vehicle (ESL) to form a slurry from the mixed copper oxide, YSZ, and other optional additives (pore formers, etc.), and then apply the slurry to an electrolyte/cathode structure that has previously been sintered. The anode/electrolyte/cathode structure then may be sintered at temperatures as low as 900° C. for as little as 4 hours to produce a solid oxide fuel cell. The sintering times may vary anywhere from about 2 hours to about 20 hours, and those skilled in the art will be capable of sintering the anode-containing structure at a suitable temperature and for a suitable period of time, using the guidelines provided herein.

The low-temperature sintering technique described in the embodiments enables the production of a copper-containing anode that contains copper in amounts higher than that achieved using impregnation or other coating techniques. In addition, because the sintering takes place at a temperature below that at which the copper will melt, the anode preferably contains no or negligible amounts of melted copper. As stated above, conventional sintering of an anode precluded the use of copper oxide because it would melt at the conventional sintering temperatures. As a consequence, previous techniques first formed a porous YSZ anode frame on an electrolyte material. In a subsequent step, copper and ceria were added by wet impregnation of aqueous salts, followed by drying and calcination. The impregnation, drying and calcination processes were typically repeated 8-10 times to achieve appropriate amounts of copper and ceria content in the anode. The concentrations of copper and ceria in the anode achievable by known impregnation and other coating procedures are significantly less than that achievable with the embodiments described herein, which form a copper-containing cermet with a ceramic electrolyte material.

Any ceramic electrolyte material can be used to prepare the copper cermet that is useful in preparing the anode. Preferred ceramic electrolyte materials include, but are not limited to yttria-stabilized zirconia (YSZ), partially stabilized zirconia (PSZ), Gc- or Sm-doped ceria (10 to 100 wt %), Sc-doped ZrO₂ (up to 100 wt %), doped LaGaMnOₓ, and other electrolyte materials. It is understood that the embodiments are not limited to these particular ceramic materials, and that other ceramic materials may be used in the anode alone or together with the aforementioned ceramic materials.

In another embodiment, the addition of ceria to the anode may improve the performance of the anode. However, the high-temperature calcination utilized in conventional anode preparation typically causes the ceria to react with YSZ, as a result of which performance is not enhanced to the extent that could be possible if formation of ceria-zirconia did not occur. It therefore is preferred to prepare the anodes at temperatures lower than conventional sintering temperatures, whereby ceria can be incorporated prior to sintering.

Another feature of an embodiment is a SOFC that comprises an air electrode (cathode), a fuel electrode (anode), and a solid oxide electrolyte positioned at least partially between these two electrodes. In a SOFC, the electrolyte is in solid form. Any material now known or later discovered can be used as the cathode material and as the electrolyte material. Typically, the electrolyte is made of a nonmetallic ceramic, such as dense yttria-stabilized zirconia (YSZ) ceramic, the cathode is comprised of doped lanthanum manganite. In the solid oxide fuel cell, hydrogen or a hydrocarbon is commonly used as the fuel and oxygen or air is used as the oxidant. Other electrolyte materials useful in the embodiments include Sc-doped ZrO₂, Gd- and Sm-doped CeO₂, and LaGaMnOx. Cathode materials useful in the embodiments include composites with Sr-doped LaMnO₃, LaFeO₃, and LaCoO₃, or metals such as Ag.

In a preferred embodiment, the electrolyte and cathode should be prepared first by tape casting the respective layers into green tapes, and sintering the multi-layered tape at conventional sintering temperatures to form a porous cathode material and a relative dense electrolyte layer. The respective thicknesses of the layers can vary, and skilled artisans are capable of fabricating a cathode-supported electrolyte having a wide variety of thicknesses, using the guidelines provided herein. The anode layer then is formed on the side of the electrolyte opposite from the cathode, using the techniques described above.

To form the cathode-supported cell, it is preferred first to form a powder of yttria stabilized zirconia (YSZ), and tape casting to form a two-layer, green tape of YSZ (one layer for the cathode and the other for the electrolyte). The cathode layer typically will contain a YSZ powder, a cathode material (e.g., (La_{0.8}Sr_{0.2})_{0.98}MnO3 (LSM, commercially available from Praxair, Danbury, Conn.), and other additives and pore formers, such as starch and the like. The electrolyte layer preferably contains YSZ and a sintering aid to enable low temperature sintering of the cathode and the anode. In one embodiment where a cathode-supported cell is prepared (as is described in this paragraph), the use of a sintering aid is optional, whereby the presence of an already sintered cathode/electrolyte structure enables low temperature sintering of the subsequent anode, and consequently, the ability to use a copper-cermet in the anode.

The two-layer green tape (YSZ-sintering aid/cathode perovskite) then preferably is sintered at temperatures within the range of from about 1,100 to about 1,800° C, preferably from about 1,200 to about 1,400° C., and most preferably from about 1,225 to about 1,300° C. to form a porous matrix of LSM/YSZ as the cathode layer, and a relative dense YSZ as the electrolyte. The porosity of the resulting cathode preferably is within the range of from about 30% to about 50%, by water-uptake measurements. Sintering the two-layer tape in this manner results in a YSZ wafer having a dense side, approximately 10 to about 80 μm thick, more preferably about 15 μm thick, supported by a porous cathode layer, approximately 400 to about 800 μm thick, more preferably about 600 μm thick. A similar procedure can be used to form an anode-supported cell, as will be appreciated by those skilled in the art. In this case, an anode cermet would be used instead of the cathode perovskite material, and the sintering temperature would be lower, within the ranges described above with respect to forming the anode.

The anode in the cathode supported cell preferably is formed by the methods described above, wherein a YSZ and copper oxide powder are mixed, together with other optional additives, formed into a slurry, and deposited onto the side of the electrolyte opposite the porous cathode. The resulting structure then is sintered at a temperature below the melting point of copper to form a porous anode structure. In certain embodiments it may be desirable to then impregnate the porous YSZ-copper cermet portion of the wafer with an aqueous solution of Ce(NO₃)₃.6H₂O and to then calcine at a temperature sufficient to decompose the nitrate ions. Preferably, calcination is carried out at a temperature within the range of from about 300 to about 700° C., more preferably from about 400 to about 600° C., and most preferably about 450° C. Alternatively, ceria could be admixed with the copper oxide powder and YSZ to form a copper-ceria cermet, and then the resulting structure sintered at a temperature below the melting point of copper, and below the temperature at which solid state reactions take place with the ceria.

The type of ceramic material employed in the electrolyte is not critical to the embodiments, although the same or similar ceramic should be used as the basis for the cathode, anode, and electrolyte to match as closely as possible the coefficient of thermal expansion (cte) of the respective layers. The embodiments likewise are not limited to any particular cathode materials.

In a similar manner, the embodiments are not particularly limited to any design of the SOFC. Several different designs for solid oxide fuel cells have been developed, including, for example, a supported tubular design, a segmented cell-in-series design, a monolithic design, and a flat plate design. All of these designs are documented in the literature, including, for example, those described in Minh, “High-Temperature Fuel Cells Part 2: The Solid Oxide Cell,” Chemtech., 21:120-126 (1991).

The tubular design usually comprises a closed-end porous zirconia tube exteriorly coated with electrode and electrolyte layers. The performance of this design is somewhat limited by the need to diffuse the oxidant through the porous tube. Westinghouse has numerous U.S. patents describing fuel cell elements that have a porous zirconia or lanthanum strontium manganite cathode support tube with a zirconia electrolyte membrane and a lanthanum chromate interconnect traversing the thickness of the zirconia electrolyte. The anode is coated onto the electrolyte to form a working fuel cell tri-layer, containing an electrolyte membrane, on top of an integral porous cathode support or porous cathode, on a porous zirconia support. Segmented designs proposed since the early 1960s (Minh et al., Science and Technology of Ceramic Fuel Cells, Elsevier, p. 255 (1995)), consist of cells arranged in a thin banded structure on a support, or as self-supporting structures as in the bell-and-spigot design.

A number of planar designs have been described which make use of freestanding electrolyte membranes. A cell typically is formed by applying single electrodes to each side of an electrolyte sheet to provide an electrode-electrolyte-electrode laminate. Typically these single cells are then stacked and connected in series to build voltage. Monolithic designs, which characteristically have a multi-celled or “honeycomb” type of structure, offer the advantages of high cell density and high oxygen conductivity. The cells are defined by combinations of corrugated sheets and flat sheets incorporating the various electrode, conductive interconnect, and electrolyte layers, with typical cell spacings of 1-2 mm for gas delivery channels.

U.S. Pat. No. 5,273,837 describes sintered electrolyte compositions in thin sheet form for thermal shock resistant fuel cells. The method for making a compliant electrolyte structure includes pre-sintering a precursor sheet containing powdered ceramic and binder to provide a thin flexible sintered polycrystalline electrolyte sheet. Additional components of the fuel cell circuit are bonded onto that pre-sintered sheet including metal, ceramic, or cermet current conductors bonded directly to the sheet as also described in U.S. Pat. No. 5,089,455. U.S. Pat. No. 5,273,837 describes a design where the cathodes and anodes of adjacent sheets of electrolyte face each other and where the cells are not connected with a thick interconnect/separator in the hot zone of the fuel cell manifold. These thin flexible sintered electrolyte-containing devices are superior due to the low ohmic loss through the thin electrolyte as well as to their flexibility and robustness in the sintered state. The disclosures of these patents are incorporated by reference herein in their entireties.

Another approach to the construction of an electrochemical cell is disclosed in U.S. Pat. No. 5,190,834 Kendall, the disclosure of which is incorporated by reference herein in its entirety. The electrode-electrolyte assembly in that patent comprises electrodes disposed on a composite electrolyte membrane formed of parallel striations or stripes of interconnect materials bonded to parallel bands of electrolyte material. Interconnects of lanthanum cobaltate or lanthanum chromite bonded to a yttria stabilized electrolyte are suggested. The SOFC of the present embodiment may be prepared using any of the techniques described above to provide the desired design, albeit a tubular cell, a monolithic cell, a flat plate cell, and the like. Using the guidelines provided herein, those skilled in the art will be capable of fabricating a SOFC including the hereindescribed anode having any desired design configuration.

The embodiments now will be explained with reference to the following non-limiting examples

### EXAMPLES

### Making the SOFC

A cathode-supported electrolyte first was prepared as follows. The cathode powders of YSZ (commercially available from Tosoh Corporation, Tokyo, Japan), (La_{0.8}Sr_{0.2})_{0.98}MnO3 (LSM, Praxair) and starch in a weight ratio of 40:40:20 were mixed with organic binders (dispersant, solvents, binder and plasticizer) and tape-casted. The electrolyte tapes were prepared similarly. The two types of tapes were laminated together and co-sintered at 1275° C. for 4 hours.

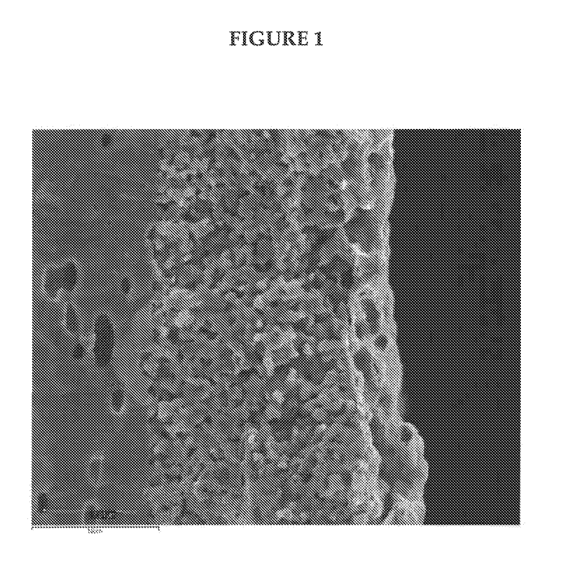

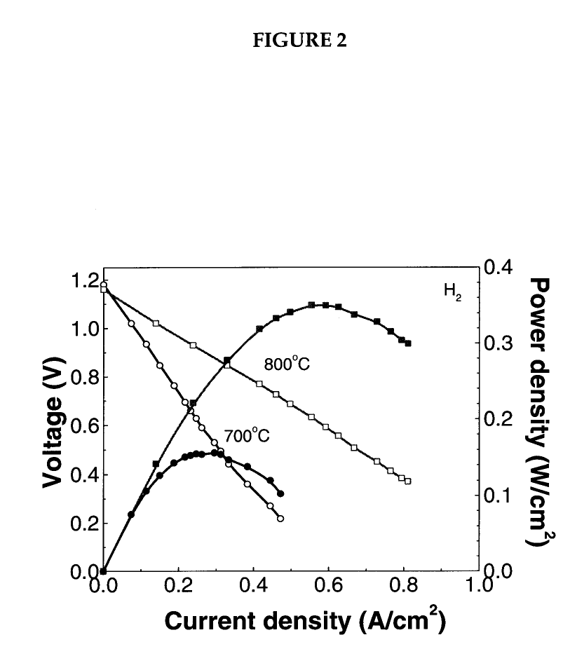

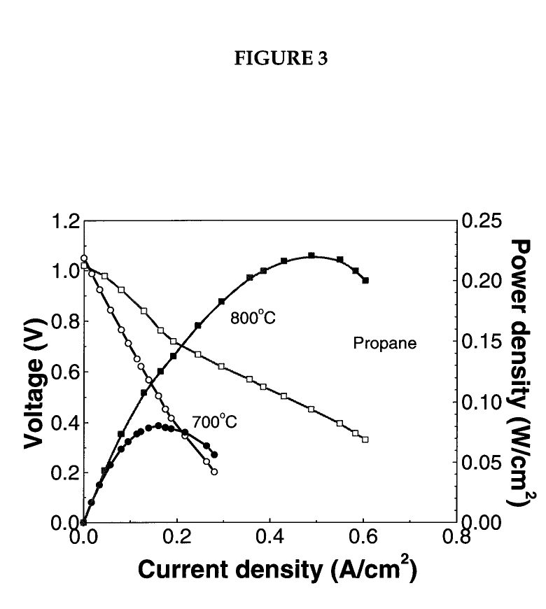

The CuO-YSZ or samaria doped ceria (SDC) anodes were prepared by mixing CuO powder (Alfa) with YSZ or SDC powder in a weight ratio of 50:50. A screen printing vehicle (ESL) was added to the mixed powder to make a slurry. The slurry was applied onto the YSZ electrolyte coating on the side of the electrolyte opposite the cathode, and fired at 900° C. for 4 h. In order to improve the catalytic activity of the anode, ceria was added by impregnation of Ce(NO₃)₃ solution, followed by drying and calcinations. Since the anode layer was only 15-40 microns, the infiltration process could be complete in one or two steps, giving an anode composition of 45% CuO-45%YSZ-10% CeO₂. The anode microstructure was shown in FIG. 1. The cell performance is shown in FIGS. 2 and 3, where FIG. 2 provides cell performance in H₂, and FIG. 3 provides cell performance in propane.

### Testing the SOFC and Inventive and Comparative Anodes

For fuel cell tests, the copper anode sides of the cells were sealed to alumina tubes using ceramic sealing (Ceramabond, commercially available from Aremco). Gold and silver ink were painted on the anode and cathode sides to form current collector grids, respectively. The SOFCs were tested in a tube furnace at temperatures from 700° C. to 800° C. Ambient air was maintained on the cathode side. The fuel flow rate (hydrogen or propane) was controlled by the mass flowmeters.

What is claimed is:

1. An anode comprising:
a porous ceramic mixture of at least copper and a ceramic electrolyte material,
whereby the porous ceramic mixture contains a higher percentage of copper by weight than that achieved by impregnating a porous ceramic electrolyte material with a copper-containing solution, or by coating a porous ceramic material with copper.

2. The anode of claim 1 wherein the ceramic electrolyte material is selected from the group consisting of yttria-stabilized zirconia (YSZ), partially stabilized zirconia (PSZ), Gc- or Sm-doped ceria, Sc-doped ZrO₂, doped LaGaMnOₓ and mixtures thereof.

3. The anode of claim 2, wherein the ceramic electrolyte material is yttria-stabilized zirconia or Sm-doped ceria.

4. The anode of claim 1, wherein the porous ceramic mixture is comprised of a mixture of copper and a ceramic electrolyte material in an amount within the range of from about 30:70 to 70:30 weight ratio of copper to ceramic electrolyte material.

5. The anode of claim 4, wherein the porous ceramic mixture is comprised of a mixture of copper and a ceramic electrolyte material in an amount within the range of from about 40:60 to about 60:40 weight ratio of copper to ceramic electrolyte material.

6. The anode of claim 4, wherein the porous ceramic mixture is comprised of a mixture of copper and a ceramic electrolyte material in an amount of about 50:50 weight ratio of copper to ceramic electrolyte material.

7. A method of making a porous ceramic anode material comprising:
forming a ceramic mixture by mixing a ceramic electrolyte material and copper oxide powders to form a copper cermet anode mixture;
mixing a ceramic electrolyte material and a sintering aid selected from the group consisting of copper oxides, iron oxides, cobalt oxides and manganese oxides, to provide an electrolyte mixture;
forming a structure by positioning the copper cermet anode mixture adjacent the electrolyte mixture; and
sintering the structure at a temperature lower than the temperature required to sinter the respective materials without the use of a sintering aid.

8. The method of claim 7, wherein the sintering aid is added in an amount effective to reduce the sintering temperature of the electrolyte/electrode composite to less than about 1,200° C., and the method comprises sintering the ceramic mixture at a temperature of less than about 1,200° C. for a period of time sufficient to form a porous ceramic anode material

9. The method of claim 7, wherein the sintering aid is at least a copper oxide.

10. The method of claim 7, wherein the sintering aid is present in an amount within the range of from about 0.1% to about 10% by weight sintering aid, based on the total weight of the electrolyte.

11. The method of claim 10, wherein the sintering aid is present in an amount within the range of from about 2.0% to about 5.0% by weight sintering aid, based on the total weight of the electrolyte.

12. The method of claim 7, wherein sintering the structure comprises sintering at a temperature of less than about 1,000° C.

13. The method of claim 7, wherein sintering the structure comprises sintering at a temperature of about 900° C. for about 4 hours.

14. A method of making an electrode comprising:
mixing a ceramic electrolyte material and an electrode material to form an electrode mixture;
mixing a ceramic electrolyte material and a sintering aid to form an electrolyte mixture;
forming a layered composite structure of the electrode material and electrolyte material; and
sintering the electrode material and electrolyte material at a temperature lower than the temperature required to sinter the respective materials without the use of a sintering aid to form a porous electrode/electrolyte composite.

15. The method of claim 14, wherein the electrode is a cathode.

16. The method of claim 14, wherein the sintering aid is selected from the group consisting of copper oxides, iron oxides, cobalt oxides, manganese oxides, and mixtures thereof.

17. The method of claim 14, further comprising:
mixing another ceramic electrolyte material and an electrode material to form a second electrode mixture;
applying the second electrode mixture to the electrode/electrolyte composite on the side of the electrolyte opposite the electrode to provide an electrode/electrolyte/second electrode composite; and
sintering the electrode/electrolyte/second electrode composite at a temperature lower than the temperature required to sinter the respective materials without the use of a sintering aid to form a solid oxide fuel cell.

18. A solid oxide fuel cell comprising a solid electrolyte, a cathode material, and the anode claimed in claim 1.

19. A method of making a solid oxide fuel cell comprising:
forming a porous ceramic anode material and electrolyte as claimed in claim 7;
contacting a surface of the electrolyte opposite the surface adjacent the porous ceramic anode material with a cathode material; and
forming the cathode.

20. The method of claim 19, wherein the cathode material is comprised of a mixture of yttria-stabilized zirconia (YSZ) ceramic and doped lanthanum manganite.

21. A solid oxide fuel cell electrolyte comprising a sintered mixture of a ceramic electrolyte material and a conductive material in an amount within the range of from about 0.1% to about 10% by weight conductive material, based on the total weight of the electrolyte.

22. The solid oxide fuel cell electrolyte as claimed in claim 21, wherein the conductive material is a sintering aid selected from the group consisting of copper oxides, iron oxides, cobalt oxides and manganese oxides.

23. The solid oxide fuel cell electrolyte as claimed in claim 21, wherein the ceramic electrolyte material is selected from the group consisting of yttria-stabilized zirconia (YSZ), partially stabilized zirconia (PSZ), Gc- or Sm-doped ceria, Sc-doped ZrO₂, doped LaGaMnOₓ and mixtures thereof.

24. A method of making a solid oxide fuel cell electrolyte comprising:
mixing a ceramic electrolyte material and a conductive material in an amount within the range of from about 0.1% to about 10% by weight conductive material, based on the total weight of the electrolyte, to provide an electrolyte mixture; and
sintering the structure at a temperature lower than the temperature required to sinter the respective materials without the use of a conductive material.

25. The method of claim 24, wherein sintering comprises sintering at a temperature of less than about 1,000° C.

26. The method of claim 24, wherein the conductive material is a sintering aid selected from the group consisting of copper oxides, iron oxides, cobalt oxides and manganese oxides.

27. The method of claim 24, wherein the ceramic electrolyte material is selected from the group consisting of yttria-stabilized zirconia (YSZ), partially stabilized zirconia (PSZ), Gc- or Sm-doped ceria, Sc-doped ZrO₂, doped LaGaMnOₓ and mixtures thereof.
